(19) United States
(12) Patent Application Publication
(10) Pub. No.: US 2010/0079551 A1
(43) Pub. Date: Apr. 1, 2010

(54) SUBSTRATE FOR LIQUID DISCHARGE HEAD, METHOD OF MANUFACTURING THE SAME, AND LIQUID DISCHARGE HEAD USING SUCH SUBSTRATE

(75) Inventors: Ichiro Saito, Yokohama-shi (JP); Kazuaki Shibata, Yokohama-shi (JP); Takahiro Matsui, Yokohama-shi (JP); Sakai Yokoyama, Kawasaki-shi (JP); Teruo Ozaki, Yokohama-shi (JP)

Correspondence Address: FITZPATRICK CELLA HARPER & SCINTO, 1290 Avenue of the Americas, NEW YORK, NY, 10104-3800, US

(73) Assignee: CANON KABUSHIKI KAISHA, Tokyo (JP)

(21) Appl. No.: 12/530,366

(22) PCT Filed: May 23, 2008
(86) PCT No.: PCT/JP2008/059954

§ 371 Date: Sep. 8, 2009

(30) Foreign Application Priority Data
May 29, 2007 (JP) 2007-141773
Aug. 1, 2007 (JP) 2007-200935
Mar. 27, 2008 (JP) 2008-083726

(51) Int. Cl. B41J 2/05; B05D 5/12

(52) U.S. Cl. 347/64; 427/124

(57) ABSTRACT

The invention provides a substrate for a liquid discharge head having a heat generating resistor layer, wiring electrically in contact with the heat generating resistor layer, an insulating protection layer that covers the heat generating resistor layer and the wiring, and a liquid passage that are formed in order on an insulating layer formed on a base plate. The insulating protection layer being a layer formed by radical shower CVD.

### TECHNICAL FIELD

The present invention relates to a substrate for a liquid discharge head for discharging liquid, a method of manufacturing the substrate, and a liquid discharge head using such a substrate for a liquid discharge head.

### BACKGROUND ART

The ink jet recording method is characterized in that a small quantity of ink is discharged as liquid droplets from a discharge port at high speed whereby a high definition image can be recorded at high speed. Technologies for discharging not only ink but also various kinds of liquid using this liquid discharge method have been developed.

Ink jet heads (which will be simply referred to as recording heads hereinafter) for implementing the ink jet recording method can be categorized into several types according to the discharge principles. Nowadays, ink jet heads that discharge ink utilizing heat energy and have a structure in which a heat generating portion and a discharge port for discharging ink associated with the heat generating portion are formed on a silicon base plate are commonly used. Commonly used substrates for ink jet heads have a structure in which a plurality of heating portions (heaters) for heating ink to form a bubble in the ink and wiring for providing electrical connections to the heating portions are formed on the same base plate. Such structures can be manufactured using the process same as that for manufacturing semiconductor devices. Therefore, by adopting this structure, a substrate for an ink jet head in which a number of heat generating resistor layers with electric wiring etc. are provided at high density can be produced easily with high precision using the process the same as that for manufacturing semiconductor devices. This enables higher definition and higher speed in recording to be achieved. This also enables the size of ink jet heads and recording apparatuses equipped with such ink jet heads to be reduced further.

FIG. 1 is a schematic plan view showing a general configuration of a heating portion formed on a base plate of a substrate for an ink jet head that uses an ink as the liquid to be discharged and portions relevant thereto. A heat generating resistor layer 1104 is formed on a base plate 1100, and a wiring layer 1105 is formed in such a way as to cover the heat generating resistor layer 1004. A part of the wiring layer 1105 has been removed, where the heat generating resistor layer is exposed to constitutes a heat generating portion 1104′.

The wiring is connected with a drive circuit. In the case where the drive circuit is formed on the base plate 1100, it is connected with an external power source via a connection terminal provided in the drive circuit. In the case where a drive circuit is provided externally of the base plate 1100, the drive circuit and the wiring are connected via a connection terminal provided on the wiring.

The heat generating resistor layer 1104 is made of a material having a high electric resistance such as TaSiN. When the heat generating resistor layer 1104 is supplied with current from outside through the wiring layer 1105, thermal energy is generated with generation of heat in the heat generating portion 1104′, whereby a bubble is generated in the ink.

FIG. 14 is a cross sectional view of the substrate for an ink jet head shown in FIG. 1 taken along line II-II. In this substrate for an ink jet head, an Si base plate is used as the base plate 120. On the Si base plate 120 is a heat storage layer 106 constituted by an SiO₂ layer, which has been formed, for example, by thermal oxidation. On the heat storage layer 106 are provided heat generating resistor layer 107 for giving thermal energy to ink and wiring 103, 104 for applying a voltage to the heat generating resistor layer 107. The portion of the heat generating resistor layer 107 that is exposed between the wiring portions constitutes a heat generating portion 102. On the heat generating resistor layer 107 and the wiring 103, 104 is provided an insulating protection layer 108 to protect them. On the insulating protection layer 108 is provided a Ta layer 110 as a cavitation resistant layer.

An ink flow passage (not shown) that is in communication with a discharge port is provided at least on the heat generating portion 102. Thus, the portion on the heat generating portion 102 will be in contact with liquid ink. If the wiring 103, 104 made of a metal and the heat generating portion 102 are in contact with ink, they will be damaged chemically by, for example, erosion. In addition, these portion are likely to be damaged physically by mechanical impact resulting from cavitation due to repetitive creation and disappearance of bubbles in the ink on the heat generating portion. In view of this, the insulating protection layer 108 for protecting and insulating these portions and the Ta layer 110 serving as an upper protection layer are provided. Furthermore, since these portions are used in a severe environment in which, for example, they experiences temperature rise and fall of 1000° C. or so in a very short time (e.g. 0.1 to 10 micro seconds), the insulating protection layer 108 and the Ta layer 110 also serve to protect these portions in such a use environment.

Therefore, the protection layer is required to be superior in heat resistance, liquid resistance, liquid filtration resistance, stability against oxidation, insulating performance, breakage resistance and thermal conductivity, and an inorganic compound layer such as a silicon oxide layer or silicon nitride layer is typically used as the protection layer. Providing only the insulating protection layer 108 such as a silicon oxide layer or a silicon nitride layer may sometimes be inadequate in protecting the heat generating resistor layer. Hence an upper protection layer made of a metal like the Ta layer 110 that has high cavitation resistance is provided on the insulating protection layer 108 in many cases, as shown in FIG. 14.

With proliferation of digital cameras and development of high-definition digital cameras, ink jet recording apparatuses are required to record images with higher resolutions and higher image qualities at higher speeds. One solution for improvement of the resolution and image quality is to reduce the quantity of discharged ink per dot (or to reduce the diameter of ink droplets in the case where ink is discharge as droplets). The approach that has been conventionally taken to reduce the size of ink droplets is to reduce the area of the opening of the discharge port and reduce the area of the heat generating portion.

On the other hand, to meet demands for higher speeds, the following approaches have been taken:

(1) to reduce the width of the electrical pulses for driving an electrothermal conversion element, thereby increasing the drive frequency and increasing the number of times of discharge per unit time; and

(2) to increase the number of discharge ports for discharging ink, thereby increasing the recordable area per one ink discharge operation.

Among these, in the case of the approach of increasing the drive frequency, it is important that the resistance of wiring be low. In order to reduce the resistance of the wiring while using the same material, it is necessary to make the width of the wiring larger or make the layer thickness (film thickness) of the wiring larger. On the other hand, in the case of the approach of increasing the number of ink discharge ports, since a large width of wiring leads to a decrease in the number of ink discharge ports per unit area, which necessitates an increase in the size of the recording head, the layer thickness of the wiring has been made larger.

Furthermore, an increase in the thickness of the wiring layer leads to an increase in the height difference at a step portion at the boundary between the heat generating resistor layer that constitutes the heat generating portion and the wiring layer and at a step portion at the boundary between the wiring layer and the heat storage layer. In consideration of the coverage performance at the step portions, it is necessary to increase the thickness of the insulating protection layer, which makes the protection layer thicker.

However, an increase in the drive frequency and an increase in the number of the discharge ports lead to an increase in the total amount of heat generated in the heat generating portion, and the heat generated in the heat generating portion is stored in the base plate, which causes the temperature of the recording head to rise. When the temperature of the recording head becomes high, it is necessary to stop the recording operation in some cases, which leads to another problem of decreased recording throughput.

Smaller thickness of the protection layer existing between the heat generating resistor layer and the surface in contact with ink leads to higher thermal conductivity and smaller quantity of heat dissipating to portions other than ink, therefore can mitigate the problem of heat storage or temperature rise in the recording head, and can make the power consumption in generating bubbles smaller. In other words, the smaller the effective thickness of the protection layer on the heat generating portion is, the higher the energy efficiency is.

On the other hand, if the protection layer is too thin, the step portion of the wiring cannot be covered satisfactorily, and covering of the step portion may become deficient. As a result, penetration of ink may occur at that portion to cause erosion of the wiring or erosion of the heat generating resistor layer, which can result in lower reliability and shorter life, in some cases.

Furthermore, in some cases, pin holes or the like existing in the protection layer allow penetration of ink, which can result in erosion of the wiring or heat generating resistor layer.

In view of the above, attempts have been made to design a layer arrangement that is free from the above described problems even if the thickness of the protection layer is reduced and causes the heat generated by the heat generating portion to act on the ink efficiently so as to be used for ink discharge.

Japanese Patent Application Laid-Open No. H08-112902 discloses a configuration of a substrate shown in FIG. 13 that addresses this problem. The base plate 120 used in this substrate 101 is a silicon base plate or a silicon base plate having a built-in IC device. On the surface of the base plate 120 is provided an SiO₂ layer serving as a heat storage layer 106. On the surface of the heat storage layer 106 are further provided a heat generating resistor layer 107 or a TaN layer for constituting a heat generating portion and an Al layer serving as wiring 103, 104. The wiring patterns are formed by removing the heat generating resistor layer 107 and the Al layer in the regions other than the wiring patterns. A portion of the Al layer is removed so as to expose the heat generating resistor layer 107, whereby the heat generation portion 102 is formed in that region. This partial removal of the Al layer leads to the creation of two opposed edges of the Al layer, and the portions extending from the edges constitute Al wiring 103 and Al wiring 104 respectively. A first insulating protection layer 108a that covers the heat generating portion 102 (i.e. the exposed portion of the TaN layer serving as the heat generating resistor layer 107) and the Al wiring 103, 104 is formed. The portion of the insulating protection layer 108a in the region corresponding to the heat generating portion 102 is removed. In addition, a second insulating protection layer 108b and a Ta protection layer 110 are formed at least in the region for covering the heat generating portion 102.

By adopting the structure shown in FIG. 13, the thickness of the protection layer composed of the first and second insulating protection layers 108a, 108b and the Ta protection layer 110 can be made smaller in the region 105 above the heat generating portion 102 of the heat generating resistor layer 107 than in the other regions. As a result, energy efficiency can be improved and power consumption can be decreased. In addition, reliability as the protection layer can be enhanced, and the useful life can be elongated.

In a specific embodiment disclosed in Japanese Patent Application Laid-Open No. H08-112902, the thickness of the Al layer is specified to be 600 nm, and the thickness of the TaN layer is specified to be 100 nm. As the first insulating protection layer 108a, use is made of a PSG layer (which may be replaced by an SiO layer or other layers) having a layer thickness of 700 nm and a high wet etching rate, which has been formed by plasma CVD (Chemical Vapor Deposition). As the second insulating protection layer 108b, use is made of a silicon nitride layer having a layer thickness of 300 nm, which has been formed by plasma CVD. Here, the PSG layer and the silicon nitride layer are form at a deposition temperature equal to or higher than 300° C., and therefore the adhesiveness of the two layers is high. The Ta protection layer 110 serving as a cavitation resistant and ink resistant layer having a layer thickness of 250 nm is formed by sputtering.

Factors such as increases in the size of images to be recorded and increases in the number of output recorded sheets require a further increase in the operation speed of ink jet recording apparatuses. For this purpose, driving frequency in driving the heat generating resistor layer of the heating portion for generating heat has been made higher and the number of discharge ports has been increased. In the case where the width of wiring is made smaller with the increase in the number of discharge ports, the resistance of the wiring will become higher, if the thickness of the wiring layer remains the same. In view of this, in order to maintain low resistance of the wiring or further reduce the resistance of the wiring, it is necessary to further increase the thickness of the wiring layer.

In the configuration disclosed in Japanese Patent Application Laid-Open No. H08-112902, in order to ensure coverage performance for step portions of the wiring, an insulating protection layer (PSG layer) having a thickness of 700 nm is formed, and then a silicon nitride layer having a thickness of 300 nm that is resistant to ink is further formed on the exposed surface of the heat generating resistor layer. Since the surface of the TaN layer serving as the heat generating resistor layer is smoother than the surface of the Al layer, it is not necessary to form the layer with a large thickness in order to cover surface undulations that may exist in the case of surfaces with lower smoothness. Therefore, the thickness of the silicon nitride layer formed on the TaN layer may be made small. Furthermore, since the adhesiveness of the silicon nitride layer and the PSG layer (or silicon oxide layer) is high, making the layer thickness of the silicon nitride layer small does not leads to the occurrence of separation of the PSG layer and the silicon nitride layer at their interface. In view of high drive frequencies and small droplet diameters in recent years, it is desirable that the distance between the discharge port and the thinned portion 105 (in the heat generating region) of the insulating protection layer be designed to be small, and that the height difference between the thinned portion 105 of the insulating protection layer and the other portions thereof be designed to be small.

The layer quality of the insulating protection layer formed by plasma CVD can be enhanced by making the deposition temperature higher. To make the deposition temperature higher, it is necessary to use materials that are resistant to the deposition temperature as the materials for the wiring etc. For example, use of alloys of Al and silicon etc. or silicides such as titanium silicide will allow to make the deposition temperature higher.

However, compounds of Al and silicon etc. and silicides such as titanium silicide have higher resistances as compared to pure aluminum, and in cases where these materials are used to form the wiring, it is necessary to make the thickness of the wiring layer larger. For this reason, the insulating protection layer is required to have further improved coverage performance. Furthermore, when Al alloys are exposed to high temperature, the evenness of their surface is deteriorated in some cases. In such cases, it is necessary to further increase the layer thickness of the insulating protection layer formed on the wiring. As per the above, raising the deposition temperature causes various problems.

Furthermore, as for the film (or layer) quality, the insulating protection layer formed by plasma CVD is not sufficiently dense, and have suffered from the following problems in some cases:

(1) Although it has a certain degree of protection performance against ink, the film quality is not necessarily satisfactory, and a part of the layer is eluted by certain kinds of ink. In addition, coverage performance at step portions is not adequate in some cases, and ink may penetrate into the interior from a portion(s) at which covering is deficient to cause disconnection of wiring or disable the discharge operation; and

(2) Since its cavitation resistance is insufficient and it can be eroded by repetitive creation and disappearance of bubbles, a protection layer made of a metal such as Ta having high cavitation resistance is required to be provided.

Furthermore, since the step of the wiring portion is steep, stress concentration tends to occur at the step portion, and a crack is likely to develop from the position of the stress concentration. Therefore, in order to provide improved coverage for the step portion, it is preferred that the insulating protection layer have such a film (or layer) quality that can follow a change in the thermal and mechanical stress etc. It is considered to be preferable that use be made of a layer having a relatively soft layer quality.

However, layers having such a film quality do not necessarily have adequate resistance to ink, and there have been cases where a part of the layer was eluted by ink or ink penetrated into the interior from a portion(s) at which covering was deficient.

In view of the above, the insulating protection layer used in a liquid discharge head such as a recoding head is required to be dense and stable in both chemical and physical senses in the portion that is in contact with liquid such as ink, resistant to ink even if its thickness is made small, and superior in the coverage performance without suffering from development of cracks at the step portion.

### DISCLOSURE OF THE INVENTION

An object of the present invention is to provide a substrate for a liquid discharge head in which heat energy generated in a heat generating resistor layer in a heat generating portion can be transferred to liquid with high efficiency and reduction of power consumption can be achieved, a method of manufacturing such a substrate, and a liquid discharge head that uses such a substrate.

Another object of the present invention is to provide a substrate for a liquid discharge head that is superior in resistance to liquid, has satisfactory coverage performance for step portions and enables the liquid discharge head to perform reliable discharge operation, a method of manufacturing such a substrate, and a liquid discharge head that uses such a substrate.

A further object of the present invention to provide a reliable liquid discharge head that allows film deposition at low temperatures in the manufacturing process thereof and can reduce formation of hillocks in an aluminum layer etc. that is used as wiring.

A still further object of the present invention is to provide a liquid discharge head that allows film deposition at a relatively low temperature with small film stress in the manufacturing process thereof to suppress deformation of the chip and can be adapted for increases in the number of the nozzles and increases in the length.

A still further object of the present invention is to provide a substrate for a liquid discharge head in which a heat generating resistor layer, wiring that is electrically in contact with the heat generating resistor layer, an insulating protection layer that covers the heat generating resistor layer and the wiring, and a liquid passage are formed in order on an insulating layer formed on a base plate, wherein the insulating protection layer is a layer formed by radical shower CVD.

A still further object of the present invention is to provide a method of manufacturing a substrate for a liquid discharge head in which a heat generating resistor layer, wiring that is electrically in contact with the heat generating resistor layer, an insulating protection layer that covers the heat generating resistor layer and the wiring, and a liquid passage are formed in order on an insulating layer formed on a base plate, the method comprising forming the insulating layer on the base plate, forming the heat generating resistor layer on the insulating layer, forming a metal layer to be formed into the wiring on the heat generating resistor layer, removing a part of the metal layer to form the wiring and the heat generating resistor layer exposed through the wiring, and forming the insulating protection layer that covers the wiring and the heat generating resistor layer exposed through the wiring, wherein the insulating protection layer is formed by radical shower CVD in which a material gas and a gas for generating radicals are supplied.

Further features of the present invention will become apparent from the following description of exemplary embodiments with reference to the attached drawings.

### BRIEF DESCRIPTION OF THE DRAWINGS

FIG. 1 is a schematic plan view of a heat generating portion of a substrate for an ink jet head according to the present invention.

FIG. 2 is a cross sectional view taken along line II-II in FIG. 1

FIG. 3 is a schematic cross sectional view of a heat generating portion of another substrate for an ink jet head according to the present invention.

FIG. 4 is a schematic cross sectional view of a portion including a heat generating portion of another substrate for an ink jet head according to the present invention.

FIG. 5 is a schematic plan view of a portion including a heat generating portion in a substrate for an ink jet head according to an embodiment of the present invention.

FIGS. 6A, 6B, 6C and 6D are schematic cross sectional views illustrating a process of manufacturing the ink jet head shown in FIG. 4.

FIG. 7 is a schematic diagram showing an example of a film deposition apparatus that can be used in a process of manufacturing a substrate for an ink jet head.

FIG. 8 is a schematic diagram of a film deposition apparatus used to form an insulating protection layer according to the present invention.

FIG. 9 is a perspective view of an ink jet cartridge constructed using the ink jet head shown in FIGS. 6A, 6B, 6C and 6D.

FIG. 10 is a schematic perspective view of an ink jet printing apparatus that performs printing using the ink jet cartridge shown in FIG. 9.

FIG. 11 is a schematic diagram of another film deposition apparatus used to form an insulating protection layer according to the present invention.

FIG. 12 is a schematic cross sectional view of a heat generating portion of another substrate for an ink jet head according to the present invention.

FIG. 13 is a schematic cross sectional view of a heat generating portion of a conventional substrate for an ink jet.

FIG. 14 is a schematic cross sectional view of a heat generating portion of another conventional substrate for an ink jet.

### BEST MODE FOR CARRYING OUT THE INVENTION

The substrate for a liquid discharge head and the liquid discharge head according to the present invention can be used for discharging various liquids including inks. In the following, the present invention will be described in connection with cases where an ink is used as the liquid to be discharged. In the following description, accordingly, a liquid discharge head will be referred to as an ink jet head, and a substrate for a liquid discharge head will be referred to as a substrate for an ink jet head.

In the substrate for an ink jet head according to the present invention, an insulating protection layer with which a heat generating resistor layer and a electrode wiring layer provided thereon are covered may have any one of the following configurations:

(1) an insulating protection layer composed of a single layer formed by RS (Radical Shower)-CVD;
(2) an insulating protection layer composed of a plurality of layers formed by RS-CVD;
(3) an insulating protection layer composed of a plurality of layers including a layer formed by RS-CVD as a layer underlying at least a layer formed by Cat (catalyst)-CVD; and
(4) a insulating protection layer composed of a plurality of layers including a layer formed by RS-CVD among layers formed by normal plasma CVD.

The composition of the insulating protection layer having the above described configuration (1) may vary along the thickness direction. In any of the above described configurations (2) to (4), at least two layers among the multiple layers may have different compositions.

Radical shower CVD stands for “radical shower chemical vapor deposition”, which is abbreviated as RS-CVD. The RS-CVD, unlike with the normal plasma CVD, causes neutral radicals extracted from a plasma gas for generating radicals to react with a material gas thereby depositing a thin film on a base plate. Therefore, a dense thin film with small defects can be formed at a low temperature in the range of approximately 50 to 400° C., preferably in the range of 100 to 300° C. Thus, a denser thin film with smaller defects as compared to those produced by conventional sputtering using high energy particles or normal plasma CVD utilizing plasma can be formed at a low temperature.

As a result, film stress can be reduced, chip deformation is suppressed, and a reliable ink jet head can be provided. In addition, the protection layer formed by RS-CVD has adequate protection performance even if it is a thin film, and therefore heat energy generated by the heat generating resistor layer can be utilized efficiently. Thus, a thin film free from plasma damages can be formed by RS-CVD.

In cases where aluminum or an aluminum alloy (e.g. Al—Si) is used as the wiring, if CVD using plasma is used, surface roughness can occur due to damages by plasma in addition to base plate temperature during film deposition, in some cases. In contrast, if RS-CVD is used, since the chamber in which plasma is generated and the chamber in which the material gas is caused to react to deposit a thin film are different, the surface is not subject to damages other than temperature. Consequently, surface roughness does not occur, and need for forming a thick insulating protection layer on the Al-based wiring is eliminated.

In RS-CVD, film deposition is performed by reaction of neutral radicals and a material gas in the vicinity of the base plate. In the case of film deposition by RS-CVD on a base plate on which a step portion has been formed upon forming a heat generating portion, neutral radicals enter the step portion and react with the material gas in that portion, whereby a film (or layer) is formed. As a result, a film (layer) having good coverage performance can be provided on the step portion. Thus, since in the substrate for an ink jet head according to the present invention at least one of the layers of a multi-layered insulating protection layer is formed by RS-CVD, it can be provided with a protection layer having good coverage performance at the step portion.

In RS-CVD, furthermore, since the chamber in which high energy particles are generated and the chamber in which thin film deposition is performed are different, damages by plasma do not occur, and film stress can be controlled easily. Consequently, in cases, in particular, where a member made of an organic resin or the like is formed on the protection layer according to the present invention, thin film deposition can be performed taking into account stress balance in relation to the organic resin or the like. In connection with increases in the number of nozzles and increases in the length associated with future increase in the speed of the ink jet printer, it is feared that the base plate of the recording element itself might deform, and reducing the film stress is required for and effective in suppressing such deformation.

Catalytic CVD stands for “catalytic chemical vapor deposition, which is abbreviated as Cat-CVD. In the Cat-CVD, a source gas is brought into contact with a hot catalyst member heated to high temperature, and thin film deposition on a base plate is performed utilizing catalytic cracking on the hot catalyst member. Therefore, a dense thin film with small defects can be formed at a low temperature in the range of approximately 50 to 400° C., preferably in the range of 100 to 300° C. Thus, a denser thin film with smaller defects as compared to those produced by conventional sputtering using high energy particles or CVD utilizing plasma can be formed, and film stress can be reduced. The protection performance of the protection layer formed by Cat-CVD is maintained even if it is made as a thin film, and therefore by using a protection film in the form of a thin film formed by Cat-CVD, heat energy generated by the heat generating resistor member can be utilized efficiently.

When at least the uppermost layer that is in contact with ink is formed by Cat-CVD, the layer can be formed as a dense insulating protection layer with small stress as described above. Consequently, by forming such a layer on the protection layer formed by RS-CVD, a substrate for an ink jet head having further improved coverage performance at step portions and superior resistance to ink can be provided.

Furthermore, since the protection layer formed by Cat-CVD is denser than conventional insulating protection films and resistant to cavitation, an upper protection layer made of a metal film such as Ta may be eliminated. In addition, the film thickness of the protection layer for the heat generating portion can be made thin, which improves thermal conductivity and reduces the quantity of heat dissipating to portions other than ink. Therefore, the problem of heat accumulation in the recording head or the problem of temperature rise can be mitigated.

In order to cope with further increased speeds and resolutions of ink jet printers in the future, it is required to further increase the number of nozzles. In this case, adaptation for higher speeds is achieved not only by shortening the cycle of ink ejection from the printer head but also increasing the number of discharge ports. In the case where the number of discharge ports is increased, the number of discharge ports arranged along the transportation direction of the recording material is increased in many cases. This results in a further increase in the length of the base plate of the recording element.

Unlike with semiconductor integral circuit (LSI) chips, which have rectangular shapes close to square, and in which deformation caused by stress in a protection film (or layer) is small, chips for printer heads (or recording element base plate) have longitudinal shapes in which one side is extremely longer than the other side. For this reason, it is required and effective to reduce stress in a protection layer that can be responsible for deformation and/or breakage of the chip.

In an inkjet head of an ink jet printer of producing color images, inks of a number of colors are used to provide improved color reproducibility. Thus, inks having various pHs ranging from mild alkaline ink, neutral ink to mild acidic ink are used. Since these inks are in direct contact with the protection film (layer) and the inks are heated to generate a bubble by using thermal energy upon discharge, various conditions are imposed on the protection film used in the ink jet head.

Furthermore, insulating protection layers used in ink jet heads are required not only to have resistance to ink but also to transfer heat from the heat generating portion to ink efficiently. For this reason, they are subject to more constraints than devices that are common in the field of semiconductor devices, and it is required in designing a film to take into consideration resistance to ink and energy.

The substrate for a liquid discharge head according to the present invention uses at least a protection layer formed by RS-CVD, and the above requirement is satisfied according to the present invention.

In the following, embodiments of the present invention will be described with reference to the drawing. However, the present invention is not limited to the embodiments described in the following, but various configurations may be adopted without departing from the scope of the present invention defined by the claims insofar as the object of the present invention can be achieved.

### First Embodiment

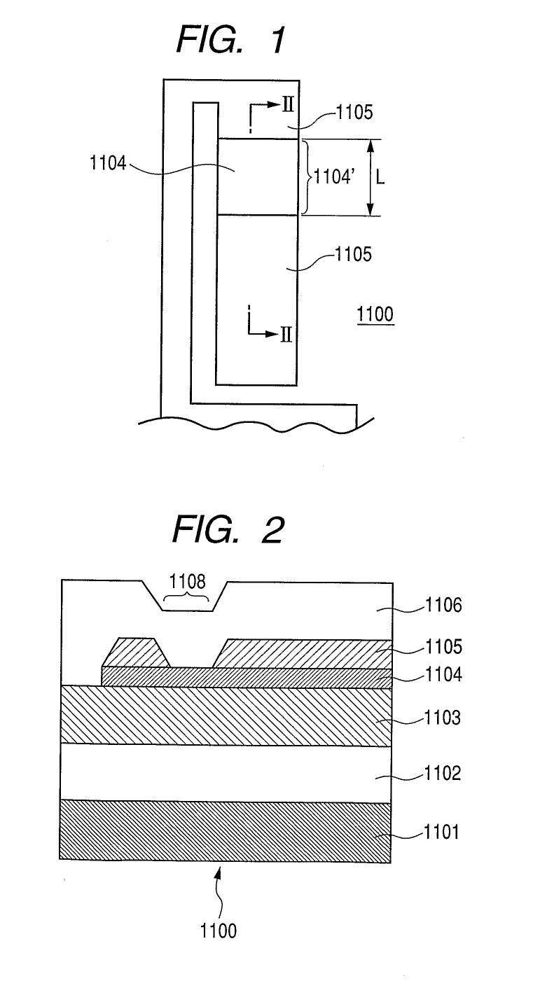

In the following, a first embodiment according to the present invention will be described in detail with reference to the accompanying drawings. FIGS. 1 and 2 are schematic plan view of a region including a heat generating portion of a substrate for an ink jet head according to a first embodiment of the present invention, and a cross sectional view thereof taken along line II-II respectively. In FIGS. 1 and 2, portions having the same functions are denoted by the same reference signs.

As shown in FIG. 1, a part of an electrode wiring layer 1105 of a wiring pattern 1105 formed in a substrate for an ink jet head 1100 has been removed, so that a heat generating resistor layer 1104 provided under the wiring pattern 1105 is exposed in that region.

As shown in FIG. 2, on a silicon base plate 1101 included in the substrate for an ink jet head 1100 are provided a heat storage layer 1102 having insulating properties and an interlaminar film 1103 in the mentioned order, and on the interlaminar film are provided the heat generating resistor layer 1104 and the electrode wiring layer 1105 in the mentioned order. The portion in which a part of the electrode wiring layer 1105 has been removed and the heat generating resistor layer 1104 is exposed constitutes a heat generating portion 1108. The heat generating resistor layer 1104 and the electrode wiring layer 1105 have the shape of the wiring pattern 1105 shown in FIG. 1. In addition, an insulating protection layer 1106 is provided on the wiring pattern 1105. A flow path or an ink flow passage is provided above the insulating protection layer 1106 (namely, on the side facing away from the heat generating resistor layer and the electrode wiring). Thus, the heat generating resistor layer, the wiring, the insulating protection layer and the ink flow passage are arranged on the insulating layer (or heat storage layer) in the mentioned order.

In the following, a method of manufacturing the above described substrate for an ink jet head will be described. First, a silicon base plate 1101 having a crystal plane orientation of <100> was prepared. By using the silicon base plate 1101 having this crystal orientation of <100>, for example, a hole that is convergent in the depth direction at an inclination angle of 54.7 degrees from the etching start surface can be formed by anisotropic etching.

The base plate 1101 used may be a silicon base plate in which a driving circuit has been built in advance.

Then, a silicon oxide layer serving as the heat storage layer 1102 having a layer thickness of 1.8 μm was formed on the base plate 1101 by thermal oxidation, and a silicon oxide layer serving as the interlaminar film 1103 having a thickness of 1.2 μm and functioning also as a heat storage layer was further formed by plasma CVD. In the case where a silicon base plate having a built-in driving circuit is used, a thermally oxidized layer formed upon forming a local oxidized layer for providing separation between semiconductor devices constituting the driving circuit may be used, and the silicon oxide layer may be formed by plasma CVD after formation of the semiconductor devices.

Then, a TaSiN layer serving as the heat generating resistor layer 1104 and an Al layer serving as the electrode wiring layer 1105 were formed by sputtering.

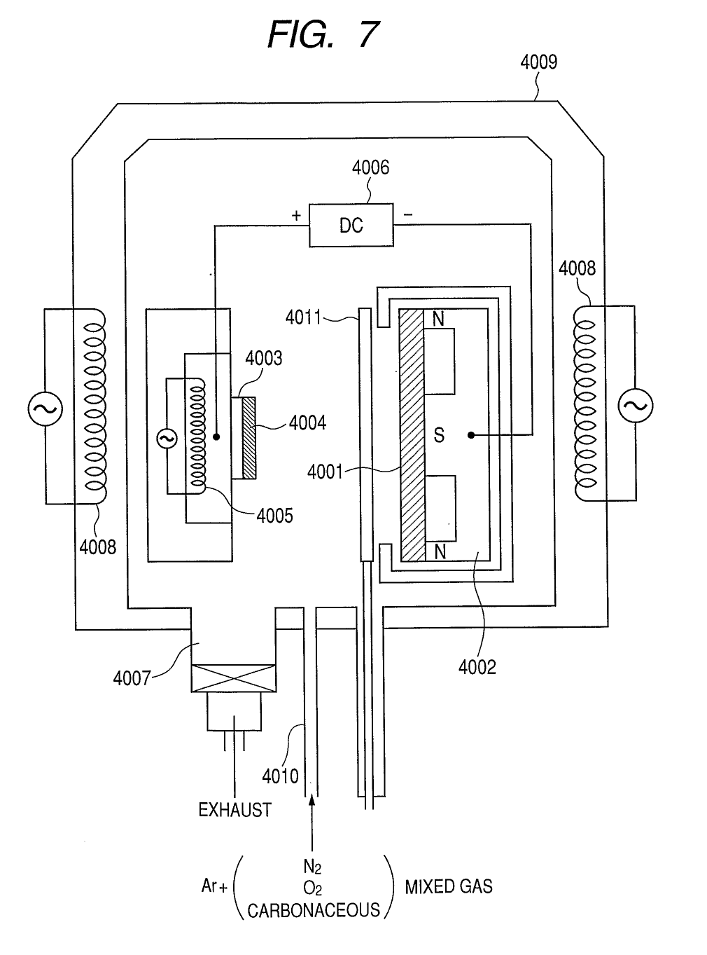

Specifically, the TaSiN layer serving as the heat generating resistor layer 1104 was first formed by reactive sputtering using Ta—Si as the alloy target. The TaSiN layer was formed using a sputtering apparatus as shown in FIG. 7. In this sputtering apparatus, a flat plate magnet 4002 is disposed in a deposition chamber 4009, and a Ta—Si target 4001 prepared to have a predetermined composition is placed on the flat plate magnet 4002. A base plate 4004 is placed on a base plate holder 4003 disposed in such a way as to be opposed to the Ta—Si target 4001. In order to maintain the temperature of the base plate at a predetermined temperature during film deposition, an internal heater 4005 for raising the temperature of the base plate holder 4003 is provided in the base plate holder 4003. A shutter 4011 is provided between the target 4001 and the base plate 4004.

A DC power source 4006 provides an electric potential difference between the target 4001 and the base plate 4004, the plus terminal of the DC power source 4006 being connected to the base plate holder 4003 and the minus terminal being connected to the target 4001. An external heater 4008 used to control the temperature in the deposition chamber 4009 is provided outside the deposition chamber 4009. The interior space of the deposition chamber 4009 is connected with an external vacuum apparatus (not shown) via an exhaust port 4007. Furthermore, the deposition chamber 4009 is provided with a gas supply port 4010 for supplying a gas during film deposition.

In forming the TaSiN layer, the deposition chamber 4009 was evacuated first, and then Ar gas and N₂ gas were supplied at flow rates of 42 sccm and 8 sccm respectively to achieve an N₂ partial gas pressure ratio of 16%. Then, a TaSiN layer having a thickness of 40 nm was formed, wherein the power supplied to the Ta—Si target was 500 w, the ambient temperature was 200° C. and the base plate temperature was 200° C. Then, an Al layer serving as the wiring layer 1105 having a thickness of 400 nm was formed in a similar manner by sputtering.

After that, dry etching was performed using a photolithographic process to pattern the heat generating resistor layer 1104 and the wiring layer 1105 simultaneously. Then, dry etching was performed by a photolithographic process to etch off or remove a part of the wiring layer 1105 to form a heat generating portion 1104′ having a size of 20 μm×20 μm that functions as a heater. In connection with the above, since it is preferable that edges of the patterned wiring layer be tapered in order to improve coverage performance of a protection layer to be formed in a later stage of the process, it is preferred that the dry etching of Al be performed in an isotropic etching condition. The etching of Al may be performed by wet etching instead of dry etching.

Thereafter, a silicon nitride layer having a thickness of 250 nm serving as the insulating protection layer 1106 was formed by RS-CVD.

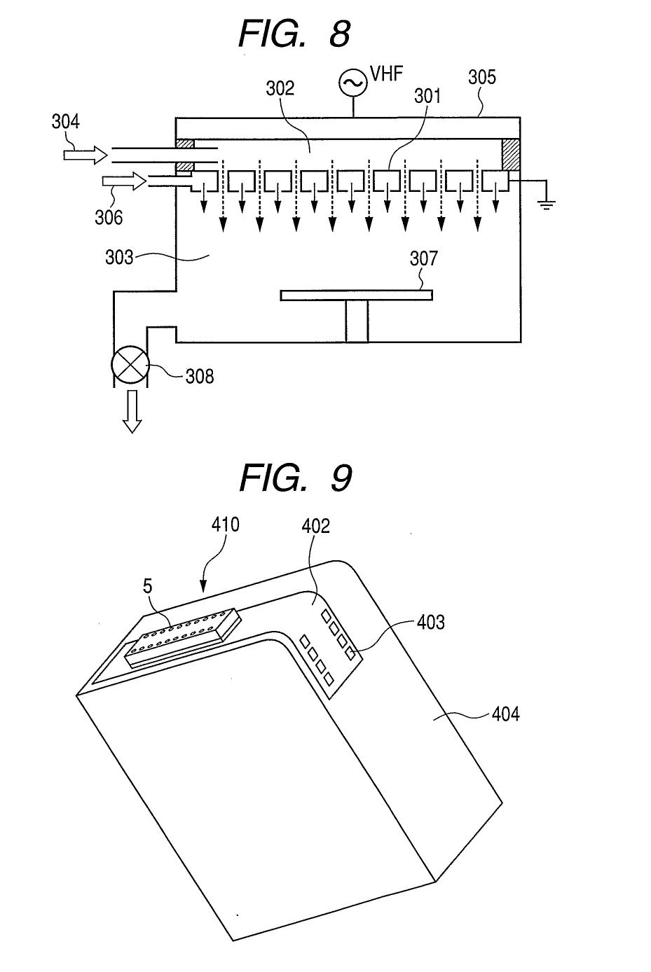

In the following, the RS-CVD apparatus will be described with reference to a schematic diagram presented as FIG. 8. The RS-CVD apparatus has a plasma chamber 302 and a deposition chamber 303 separated by a partition plate 301. The source gases used include a gas(es) for generating radicals and a material gas(es). The gas for generating radicals (e.g. NH₃ gas or oxygen gas) is introduced into the plasma chamber 302 through a gas introduction pipe 304, and a plasma discharge is produced by an electrode 305 using a high frequency (RF or VHF) power source, whereby radicals are produced and introduced into the deposition chamber 303.

The material gas is introduced into the partition plate 301 through a gas introduction pipe 306, and then introduced into the deposition chamber 303 through opening portions provided on the partition plate 301.

The radicals introduced into the deposition chamber 303 react with the material gas (e.g. SiH₄ to which Ar or He is added as a carrier gas, if need be), so that a thin film is deposited on the base plate placed on a base plate holder 307. The apparatus is provided with an evacuation pump 308 to lower the pressure in the deposition chamber 303.

As per the above, the RS-CVD apparatus is characterized in that it has the plasma chamber and the deposition chamber separated from each other, and hence the base plate on which a film is deposited is not exposed to the plasma generation reaction. Therefore, film deposition (layer deposition) that can produce a dense film having small defects is achieved.

In the case where a silicon nitride layer is to be formed, ammonia (NH₃) gas may be used as the gas for generating radicals, and as the material gas, monosilane (SiH₄) or disilane (Si₂H₆) etc. may be used together with a carrier gas such as Ar or He.

In the case where a silicon oxynitride, silicon oxycarbide or silicon carbonitride layer is to be formed, such a film can be formed by introducing oxygen gas and methane (CH₄) gas etc. as required.

To control the temperature of the base plate, a temperature control apparatus (e.g. a heater in the case where the base plate temperature is to be maintained at a high temperature, or a cooling apparatus in the case where the base plate temperature is to be maintained at a low temperature) may be provided.

In this embodiment, film deposition using the apparatus shown in FIG. 8 was performed in the following manner.

First, the deposition chamber 303 was evacuated to a pressure of 1×10⁻⁵ to 1×10⁻⁶ Pa using the evacuation pump 308. Then, NH₃ gas was introduced into the plasma chamber 302 from the gas introduction port 304 through a mass flow controller (not shown) at a flow rate of 500 sccm. Then, a power of 800 W was applied by the high frequency power source to produce a plasma, and nitrogen radicals were introduced into the deposition chamber 303 through the partition plate 301.

After that, SiH₄ gas and Ar gas were introduced from the gas introduction port 306 at flow rates of 20 sccm and 50 sccm respectively, so that a silicon nitride layer was formed by reaction of nitrogen radicals and SiH₄ gas. In this process, the deposition pressure was 20 Pa, and the deposition temperature was 300° C.

The layer thickness (or film thickness) of the deposited silicon nitride layer was 250 nm, the film stress was 200 Mpa (tensile stress).

By changing the composition of the introduced gas continuously or stepwise, an insulating protection layer such as a silicon nitride layer having a composition that varies along the layer thickness direction can be formed.

For example, by changing the flow rates of the NH₃ gas and SiH₄ gas, an insulating protection layer in the form of a silicon nitride layer having a varying composition can be formed.

By adding oxygen in addition to the above mentioned source gases of NH₃ and SiH₄, a silicon oxynitride layer can be formed.

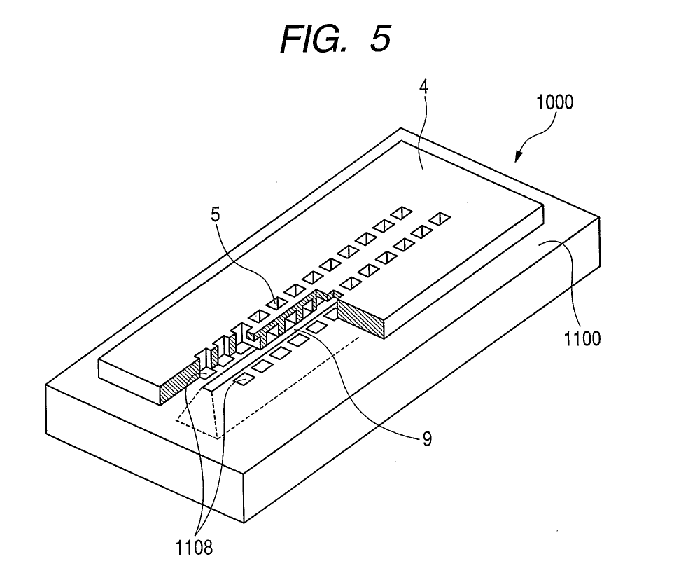

In the following, an ink jet head that is constructed using the above described substrate for an ink jet head 1100 will be described with reference to a schematic perspective view presented as FIG. 5.

In the ink jet head 1000, a substrate for an ink jet head 1100 provided with two parallel rows of heat generating portions 1008 arranged at a certain pitch is used. Specifically, the parallel rows may be provided by disposing two substrates for an inkjet head 1100 in such a way that their respective edges closest to the row of the heat generating portions 1008 are opposed to each other, or two parallel rows of heat generating portions 1108 may be prepared on one substrate for an ink jet head.

A member (flow passage forming member) provided with discharge ports 5 is attached on the substrate for an ink jet head 1100 provided with heat generating portions 1108 in such a way that the discharge ports 5 are aligned with the positions of the heat generating portions 1108, whereby the ink jet head 1000 is constructed. The member (flow passage forming member) 4 has ink discharge ports 5, a liquid chamber portion (not shown) in which ink introduced from outside is to be stored, an ink supply port 9 associated with the discharge ports 5 for supplying ink from the liquid chamber, and a flow passage providing communication between the discharge ports 5 and the supply port 9.

Although in the illustration of FIG. 5 the heat generating portions 1108 and the ink discharge ports 5 in the respective rows are arranged in line symmetry, the heat generating portions 1108 and the ink discharge ports 5 in the respective rows may be offset by half pitch, whereby the recording resolution can be further increased.

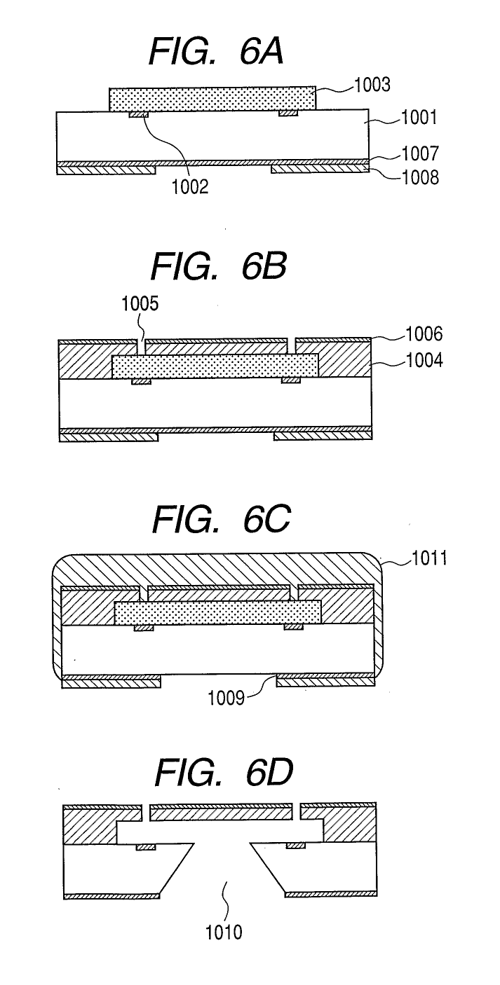

FIGS. 6A to 6D are schematic cross sectional view illustrating a process of manufacturing the ink jet head shown in FIG. 5.

A patterning mask 1008 resistant to alkaline used to form an ink supply port 1010 is formed on a silicon oxide layer 1007 formed on the backside surface of a substrate for an ink jet head 1001 provided with heat generating portions 1002.

A patterning mask for the silicon oxide layer can be formed in the following manner. First, a mask material is applied on the entire backside surface of the base plate 1001 by, for example, spin coating, and then thermally cured. Then, a positive resist (not shown) is applied on the mask material by, for example, spin coating. Then patterning of the positive resist is performed using a photolithography technique, and thereafter the exposed portion of the mask material that will become the patterning mask 1008 is removed by, for example, dry etching using the positive resist as a mask. Lastly, the positive resist is removed. Thus, the patterning mask 1008 having a desired pattern is obtained.

Next, a mold material 1003 is formed on the surface on which the heat generating portions 1108 are provided. The mold material 1003 will be dissolved away in a later process after being shaped into the shape of a flow passage, and the space occupied by the mold member will be left as an ink flow passage. For this purpose, the mold material 1003 is shaped to have an appropriate height and planer pattern in order to form an ink flow passage having a desired height and planer pattern.

As the mold material 1003, for example, a positive photoresist is used. The positive photoresist is applied on the base plate 1001 with a predetermined thickness by dry-film lamination or spin coating etc. Then, the patterning of the mold material 1003 is performed using a photolithography technique which includes exposure to e.g. UV or deep UV light and development (FIG. 6A).

After that, a material of a flow passage forming member 1004 is applied by spin coating to cover the mold material 1003 and then patterned in a desired shape using a photolithography technique. In addition, ink discharge ports 1005 are formed as openings at positions opposed to the heat generating portions 1008 using a photolithography technique.

Then, a water repellant layer 1006 is formed by, for example, laminating a dry film on the surface of the flow passage forming member 1004 on which the ink discharge ports 1005 open (FIG. 6B).

The materials that can be used as the material of the flow passage forming member 1004 include a photosensitive epoxy resins and photosensitive acrylate resins. The flow passage forming member 1004 defines the ink flow passage, and accordingly it will be continuously in contact with ink when the ink jet head is in use. In view of this, a particularly suitable material thereof is a cationic polymer produced by photoreaction. Since durability and other properties of the material of the flow passage forming member 1004 vary to a large extent depending on the kind and characteristics of the ink used, suitable compounds other than the above mentioned materials may be used, if the ink used demands.

Next, the ink supply port 1010 in the form of a through-opening passing through the base plate 1001 is formed. In this process, the surface on which functional elements of the ink jet head have been formed and side surfaces of the base plate 1001 are covered by applying protection material 1011 made of a resin or the like by, for example, spin coating so that the aforementioned surfaces will not be in contact with etching solution. As the protection material 1011, a material having adequate resistance to strong alkali solution used in anisotropic etching is used. By covering the upper surface of the flow passage forming member 4 also with the protection material 1011, deterioration of the water repellant layer 1006 can also be prevented.

After that, patterning of the silicon oxide layer 1007 is performed by, for example, wet etching while using a patterning mask 1008 that has been formed in advance, to form an etching start opening 1009 in which the backside surface of the base plate 1001 is exposed (FIG. 6C).

Next, an ink supply opening 1010 is formed by anisotropic etching while using the silicon oxide layer 1007 as a mask. The etching solution used in the anisotropic etching may be, for example, a 22 weight percent solution of TMAH (Tetra Methyl Ammonium Hydroxide). The etching is performed using this solution for a predetermined time (a dozen or so hours) while maintaining the temperature of the solution at 80° C. to form a through-opening.

After that, the patterning mask 1008 and the protection material 1011 are removed. Furthermore, the mold material 1003 is dissolved away through the ink discharge ports 1005 and the ink supply port 1010 so as to be removed, then the product is dried (FIG. 6D).

The mold material 1003 can be dissolved away by performing development after exposure of the entire surface to deep UV light has been performed. During the development, ultrasonic immersion may be performed if need be, whereby the mold material 1003 can be removed.

The ink jet head manufactured in this way can be used in apparatuses such as printers, copying machines, fax machines equipped with a communication system and word processors equipped with a printer unit, and industrial recording apparatuses combined with various processing apparatuses in multiple ways. By using this ink jet head, recording on various recording media such as paper, thread, fiber, cloth, leather, metal, plastic, glass, wood and ceramic can be performed.

In this specification, the word “recording” is intended to mean not only to provide a recording medium with a significant image such as a character or figure but also to provide a recording medium with an insignificant image such as a pattern.

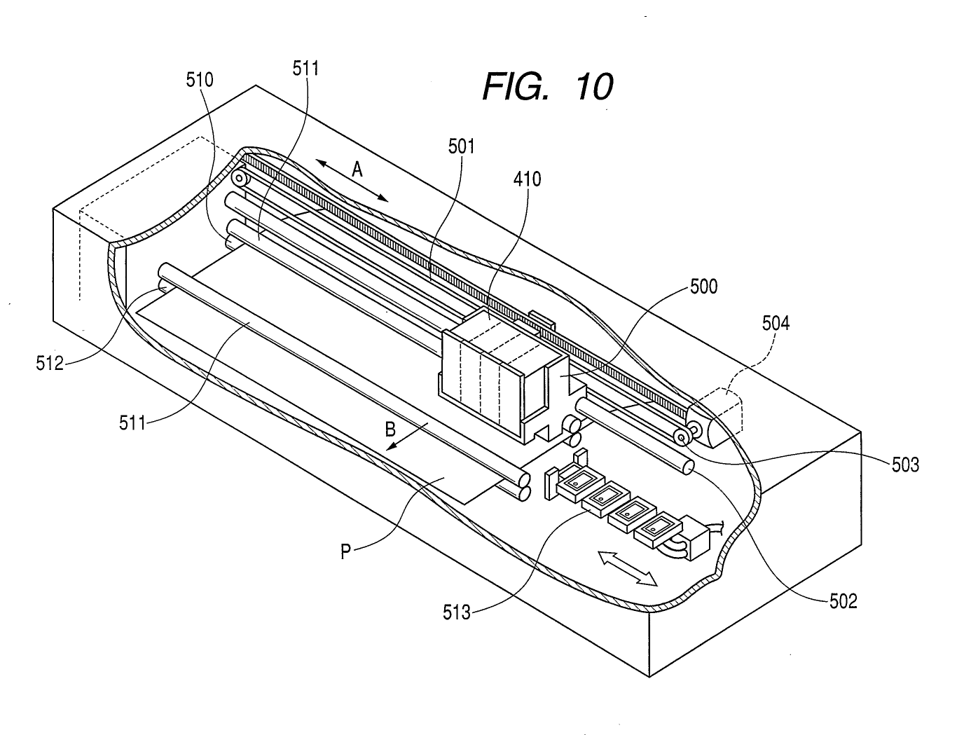

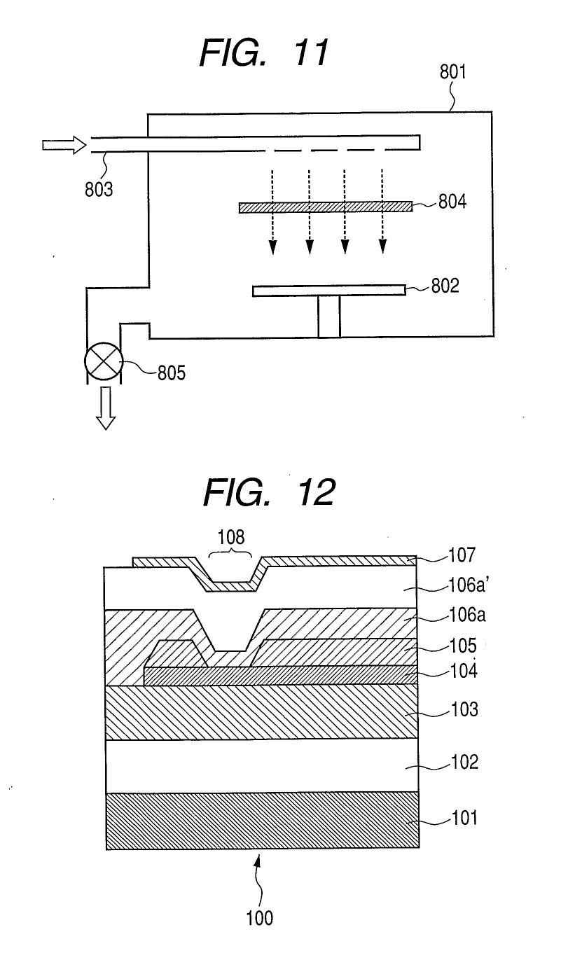

In the following, a cartridge type unit in which an ink jet head and an ink tank are integrated (FIG. 9) and an ink jet recording apparatus using that unit (FIG. 10) will be described.

FIG. 9 shows an example of an ink jet head unit 410 in the form of a cartridge that can be attached on a recording apparatus. The ink jet head unit 410 is provided with an ink jet head 5. The ink jet head 5 is disposed on a tape member 402 for TAB (Tape Automated Bonding) having terminals for power supply and coupled with an ink tank 404. The wiring in the ink jet head 5 is connected with wiring (not shown) extending from the terminals 403 of the tape member 402 for TAB.

FIG. 10 schematically shows an exemplary structure of an ink jet recording apparatus that performs recording using the ink jet head unit shown in FIG. 9.

In the ink jet recording apparatus, a carriage 500 fixedly mounted on an endless belt 501 is adapted to be movable along a guide shaft 502. The endless belt 501 is set on a pulley 503 to which a drive shaft of a carriage drive motor 504 is connected. Thus, the carriage 500 can be moved in reciprocating directions (indicated by arrow A in FIG. 10) along the guide shaft 502 in a scanning manner by rotational driving of the motor 504.

On the carriage 500 is mounted the ink jet head unit 410 in the form of a cartridge. The ink jet head unit 410 is mounted on the carriage 500 in such a way that the discharge ports 5 of the ink jet head are opposed to a paper sheet P as a recording medium and the direction of arrangement of the discharge ports 5 is oriented in a direction (e.g. sub scanning direction in which the paper sheet P is transported) different from the main scanning direction. Multiple sets of ink jet heads 410 and ink tanks 404 as many as the number of ink colors used may be provided. In the illustrated example, four sets are provided for four colors (e.g. black, yellow, magenta and cyan)

The recording sheet P as a recording medium is transported intermittently in a direction indicated by arrow B that is perpendicular to the scanning direction of the carriage 500. The recording sheet P is transported while being supported by paired roller units 510 and 511 in the upstream with respect to the transportation direction and paired roller units 511 and 512 in the downstream. Driving forces to the respective roller units are transmitted from a sheet drive motor that is not shown in the drawings.

In the above described structure, as the carriage 500 moves, recording over a width corresponding to the width of arrangement of the discharge ports of the ink jet head 410 and transportation of the sheet P are performed alternately and repeatedly, whereby recording on the entire surface of the sheet P is achieved.

At the home position of the carriage 500 is provided a cap member 513 with which the surface of the ink jet head 410 on which the discharge ports are provided (discharge port formation surface) is capped. The cap member 513 is connected with a suction restoring means (not shown) that sucks ink from the discharge ports forcibly to prevent clogging or other failures of the discharge ports from occurring.

### Second Embodiment

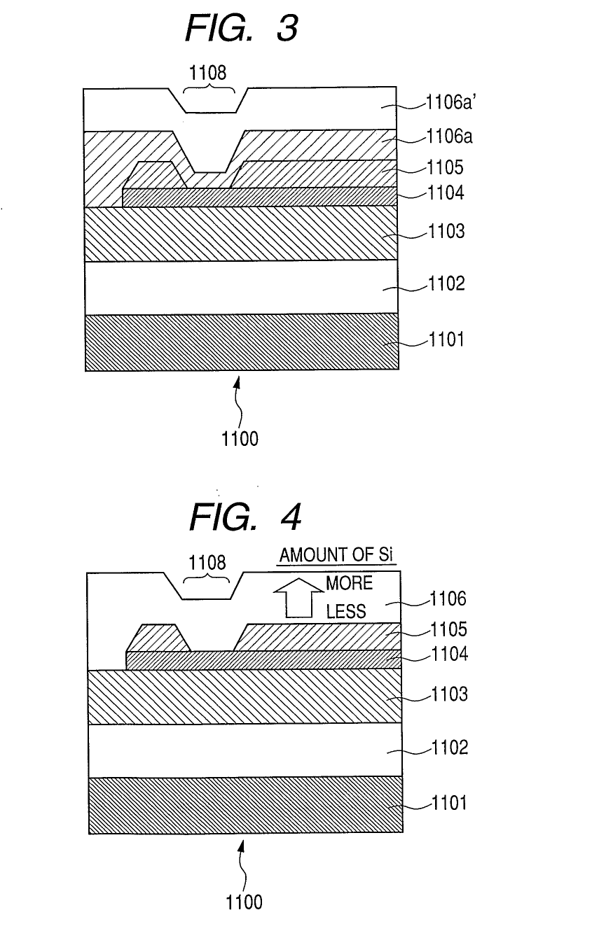

In the substrate according to the second embodiment, unlike with the configuration shown in FIG. 2, a second protection layer 1106a′ is provided on a first protection layer 1106a, both layers being formed by RS-CVD. The portions other than the insulating protection layer 1106 in FIG. 2 and the first and second protection layers 1106a and 1106a′ in FIG. 3 have the same configurations and are produced by the same processes.

First, as the first protection layer 1106a, a silicon oxynitride layer having a layer thickness of 200 nm was formed by performing deposition under the conditions of an NH₃ gas flow rate of 500 sccm, an O₂ gas flow rate of 200 sccm, an SiH₄ gas flow rate of 20 sccm, an Ar gas flow rate of 50 sccm, a deposition pressure of 20 Pa and a base plate temperature of 350° C.

Then, as the second protection layer 1106′, a silicon nitride layer having a layer thickness of 100 nm was formed by performing deposition under the conditions of an NH₃ gas flow rate of 500 sccm, an SiH₄ gas flow rate of 30 sccm, an Ar gas flow rate of 50 sccm, a deposition pressure of 15 Pa and a base plate temperature of 350° C.

In this embodiment, a silicon oxynitride layer having relatively good coverage performance was formed as the first protection layer and a silicon nitride layer having relatively good resistance to ink was formed thereon as the second protection layer, where both layers were formed using RS-CVD.

### Third Embodiment

In the third embodiment, an insulating protection layer 1106 composed of a silicon nitride layer was formed by RS-CVD while varying its composition along the layer thickness direction as shown in FIG. 4. Specifically, the silicon nitride layer was formed in such a way that the portion to be in contact with ink has a composition that contains more Si than the composition of the portion in contact with the heat generating resistor layer to thereby become a layer having superior resistance to ink.

Specifically, the flow rate of SiH₄ gas was controlled to increase from the side that is in contact with the heat generating resistor layer toward the side to be in contact with ink. First, film deposition was started under the conditions of an NH₃ gas flow rate of 500 sccm, an SiH₄ gas flow rate of 20 sccm, an Ar gas flow rate of 50 sccm, a deposition pressure of 20 Pa and a base plate temperature of 350° C. The SiH₄ gas flow rate was later changed to 25 sccm and then to 30 sccm, so that a silicon nitride layer having a thickness of 300 nm was formed.

The film stress in the silicon nitride layer in this case was −150 MPa (compressive stress).

In the case where ink liquid is alkaline, there is a possibility that silicon contained in the silicon nitride layer is eluted into the ink. Therefore, the portion to be in contact with ink may be designed to have a composition that contains less Si than the composition of the portion in contact with the heat generating resistor layer conversely to the above case, whereby a layer having good resistance to alkaline ink can be provided.

### Fourth Embodiment

In the fourth embodiment, unlike with the configuration shown in FIG. 2, an upper protection layer 110 serving as a cavitation resistant layer is formed on an insulating protection layer 108 formed by RS-CVD as shown in FIG. 12.

The upper protection layer 110 was formed as a Ta film having a thickness of 200 nm by sputtering, and then patterning was performed. Thus, the substrate for an ink jet head shown in FIG. 12 was produced.

In the fourth embodiment, the process of producing the substrate for an ink jet head is the same as that according to the first embodiment except for formation of the upper protection layer 110.

### Fifth Embodiment

The substrate according to the fifth embodiment has a configuration as shown in FIG. 2 as with the first embodiment, but a silicon nitride layer having a film thickness of 200 nm was formed under different deposition conditions in RS-CVD. As, the source gases in RS-CVD, NH₃ gas was introduced at a flow rate of 400 sccm, SiH₄ gas was introduced at a flow rate of 30 sccm, and Ar gas was introduced at a flow rate of 50 sccm, and deposition was performed at a deposition pressure of 20 Pa and a base plate temperature of 380° C.

The film stress of the silicon nitride layer in this case was 100 MPa (tensile stress).

### Sixth Embodiment

In the sixth embodiment, a silicon nitride layer was formed under the same deposition condition in RS-CVD as the first embodiment, but the layer thickness of the silicon nitride layer was different. The layer thickness was 100 nm.

### Seventh Embodiment

In the seventh embodiment, a silicon nitride layer was formed using RS-CVD under the same deposition condition as the first embodiment, but the layer thickness was different. The layer thickness was 500 nm.

### Eighth Embodiment

The substrate according to the eighth embodiment has a configuration as shown in FIG. 2 as with the first embodiment, and a silicon oxynitride layer having a layer thickness of 300 nm was formed. As the source gases in RS-CVD, NH₃ gas was introduced at a flow rate of 500 sccm, O₂ gas was introduced at a flow rate of 200 sccm, SiH₄ gas was introduced at a flow rate of 20 sccm, and Ar gas was introduced at a flow rate of 50 sccm, and deposition was performed at a deposition pressure of 20 Pa and a base plate temperature of 300° C.

The film stress of the silicon oxynitride layer in this case was 500 MPa (tensile stress).

### Ninth Embodiment

In the ninth embodiment, a silicon nitride layer was formed under the same deposition conditions in RS-CVD as the first embodiment except for that the base plate temperature during deposition was set to 50° C.

### Comparative Example 1

A substrate for an ink jet was produced in the same manner as the first embodiment except that the insulating protection layer was formed by plasma CVD.

The source gases used were SiH₄ gas and NH₃ gas, the base plate temperature was 400° C., the deposition pressure was 0.5 Pa, the layer thickness (film thickness) was 250 nm and the film stress was −900 MPa (compressive stress).

Since in the process of forming the substrates for an ink jet according to first to ninth embodiments, the temperature of the base plate was set below 400° C. and plasma was not present in the deposition chamber, which characterizes RS-CVD, no hillocks occurred on the surface of the Al layer. On the other hand, in the film deposition process according to conventional plasma CVD used in comparative example 1, the temperature of the base plate was set to 400° C. to provide a layer having good quality, and the base plate is exposed to plasma. Consequently, hillocks were found on the surface of the Al layer.

### (Evaluation of Substrate for Ink Jet Head and Ink Jet Head)

### <Result of Evaluation of Resistance to Ink>

The substrates for an ink jet head according to the first to third and fifth to ninth embodiments and comparative example 1 were immersed in an ink liquid and left in a temperature controlled bath kept at 70° C. in three days, and then the change in the layer thickness of the insulating protection layer between before and after the above process was examined.

In result, while the thickness of the silicon nitride layer in the substrate for an ink jet head according to comparative example 1 had decreased by approximately 80 nm, the silicon nitride layer in the substrates for an ink jet head according to the first to third and fifth to ninth embodiments had decreased only by approximately 20 nm. This result showed that the silicon nitride layer (film) in the embodiments had good resistance to ink.

Since layers (films) formed by RS-CVD according to the present invention have better resistance to ink than silicon nitride layers used as insulating protection films formed by conventional plasma CVD, protection performance can be ensured even if they are made thinner. Thus, a configuration having higher energy efficiency can be achieved by making the layer thickness of the insulating protection layer smaller.

### <Head Characteristics>

The ink jet heads according to the first to ninth embodiments and comparative example 1 produced using the substrates for an ink jet head according to the first to ninth embodiments and comparative example 1 were attached to an ink jet recording apparatus, and the bubble generation start voltage Vth at which ink discharge began was measured. In addition, printing durability test was performed. The test was performed by printing a general test pattern provided in the ink jet recording apparatus on A4 paper sheets. In this process, pulse signals with a drive frequency of 15 KHz and a drive pulse width of 1 μs were supplied, and the bubble generation start voltage Vth was determined. The results are shown in Table 1.

TABLE 1

| | | bubble generation | drive |
|---|---|---|---|
| | | start voltage | voltage |
| | | Vth [V] | Vop [V] |
| 1st embodiment | 250 nm | 14.0 | 18.2 |
| 2nd embodiment | 200 nm + 100 nm | 14.7 | 19.1 |
| 3rd embodiment | 300 nm | 14.6 | 19.0 |
| 4th embodiment | 250 nm + Ta 200 nm | 18.0 | 23.4 |
| 5th embodiment | 200 nm | 14.2 | 18.5 |
| 6th embodiment | 100 nm | 13.1 | 17.0 |
| 7th embodiment | 500 nm | 15.5 | 20.2 |
| 8th embodiment | 300 nm | 14.7 | 19.1 |
| 9th embodiment | 250 nm | 14.2 | 18.5 |
| comparative | 250 nm | 15.0 | 19.5 |
| example 1 | | | |

In the case of a substrate having the configuration shown in FIG. 12 and including a insulating protection layer formed by RS-CVD and an upper protection layer having a thickness of 200 nm, the bubble generation start voltage Vth was 18.0 V (fourth embodiment).

In the case of a substrate having the configuration shown in FIG. 2 including no upper protection layer an insulating protection layer in contact with ink (first embodiment), the result as shown in Table 1 was obtained, which showed that the bubble generation start voltage Vth was decreased by approximately 10% to 15%, and hence a further decrease in power consumption.

Decreases in the bubble generation start voltage Vth also occurred in the cases of the second embodiment, which has a laminated insulating protection layer, the third embodiment, which has an insulating protection layer having a composition varied along the layer thickness direction, the fifth embodiment, which has an insulating protection layer that had been deposited under different deposition conditions, the sixth and seventh embodiments, which has an insulating protection layer having a different layer thickness, the eighth embodiment provided with a silicon oxynitride layer, and the ninth embodiment, which had been formed at a decreased base plate temperature during film deposition by RS-CVD, as will be seen from Table 1.

Although the bubble generation start voltage Vth in the case of the seventh embodiment is higher than that in the case of comparative example 1, this was due to the layer thickness as large as 500 nm. If compared at an equivalent layer thickness, the seventh embodiment provides decreased power consumption.

Further, recording of a standard document containing 1500 letters was performed at a drive voltage equal to the bubble generation start voltage Vth multiplied by a factor of 1.3. All of the ink jet heads according to the first to ninth embodiments could perform recording on more than 5000 sheets, and deterioration of recording quality did not occur.

On the other hand, in the case of the ink jet head according to comparative example 1, printing was disabled after recording on approximately 1000 sheets. This was found to be due to breakage of the insulating protection layer caused mainly by cavitation and elution by ink.

As per the above, it was found that the ink jet heads to which the present invention is applied can record images stably over a long period of time and have superior durability.

### Tenth Embodiment

FIGS. 1 and 3 are schematic plan view of a region including a heat generating portion of a substrate for an ink jet head according to a tenth embodiment of the present invention, and a cross sectional view thereof taken along line II-II respectively. Details of the respective portions shown in FIGS. 1 and 3 have already been described in the description of the first and second embodiments. What is different in this tenth embodiment from these embodiment is that a first protection layer 1106a shown in FIG. 3 is formed using RS-CVD and a second protection layer 1106a′ provided thereon is formed using Cat-CVD. In view of the above, portions having like functions are denoted by like reference signs.

First, a silicon nitride layer having a film thickness of 150 nm serving as the first protection layer 1106a was formed using RS-CVD. The source gases used were SiH₄ gas and NH₃ gas, and film deposition was performed under the conditions of a base plate temperature of 400° C. and a deposition pressure of 0.5 Pa.

Secondly, a silicon nitride layer having a thickness of 100 nm was formed as the second protection layer 1106a′ using Cat-CVD, and then patterning was performed. Thus; the substrate for an ink jet head 1100 shown in FIG. 3 was produced.

The silicon nitride layer serving as the first protection layer 1106a having a layer thickness of 150 nm and a film stress of 200 MPa (tensile stress) was formed using an RS-CVD apparatus by a manufacturing method similar to the method that has been described with reference to FIG. 8.

In the following, a Cat-CVD apparatus used to form the second protection layer 1106a′ will be described with reference to schematic diagram presented as FIG. 13. This Cat-CVD apparatus has a structure in which a base plate holder 802, a heater 804 and a gas introduction portion 803 are provided in a deposition chamber 801. The Cat-CVD apparatus is further provided with an evacuation pump 805 to lower the pressure in the deposition chamber 801. The heater 804 serves as a catalyst member that causes catalytic cracking of a gas(es) to occur above the base plate holder 802. The source gases are introduced above the heater 804 through a gas introduction portion 803. The apparatus is further provided with an evacuation pump 805 to lower the pressure in the deposition chamber 801.

In the Cat-CVD, the heater 804 serving as a catalyst member is heated to cause catalytic cracking of a source gas(es) to occur utilizing catalytic reaction thereby depositing a film on a base plate placed on the base plate holder 802. By using the Cat-CVD, film deposition can be performed at lowered base plate temperatures.

When a silicon nitride layer is to be deposited, monosilane (SiH₄) or disilane (Si₂H₆) etc. may be used as a source gas, ammonia (NH₃) may be used as a source gas of nitride, and tungsten (W) may be used as a catalyst. In addition, hydrogen (H) may be added to improve coverage performance of the deposited layer. To heat the base plate, a heater may be provided in the base plate holder 802.

In this embodiment, film deposition using the apparatus shown in FIG. 13 was performed in the following manner.

First, the deposition chamber 801 was evacuated to a pressure of 1×10⁻⁵ to 1×10⁻⁶ Pa using the evacuation pump 805. Then, NH₃ gas was introduced into the deposition chamber 801 from the gas introduction port 803 through a mass flow controller (not shown) at a flow rate of 200 sccm. During this process, the heater (not shown) was controlled so as to maintain the temperature of the base plate at 300° C. Then, the heating catalyst member was heated to a temperature of 1700° C. using an external power source. Then, SiH₄ gas was introduced at a flow rate of 5 sccm, whereby a silicon nitride layer was formed by catalytic cracking of NH₃ gas and SiH₄ gas. The deposition pressure in this process was 5 Pa.

The layer thickness of the silicon nitride layer thus deposited was 100 nm and the film stress thereof was 200 MPa (tensile stress).

The configuration of an ink jet head 1000 produced using the above described substrate for an ink jet head 1100 and the process of producing the ink jet head 1000 may be the same as those described before with reference to FIGS. 5 and 6A to 6D.

The configuration of a cartridge type unit in which this ink jet head and an ink tank are integrated and the structure of an ink jet recording apparatus equipped with this unit may be the same as those described before with reference to FIGS. 9 and 10.

### Eleventh Embodiment

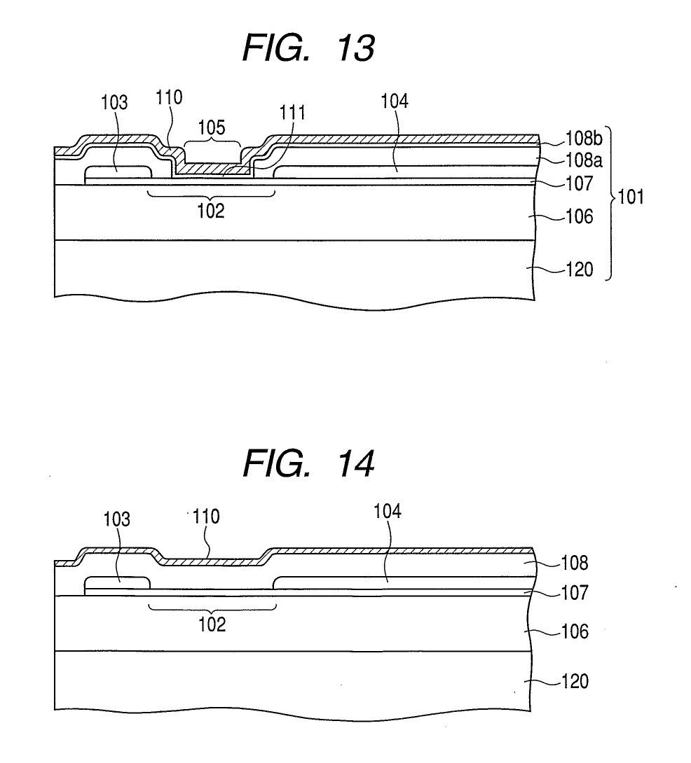

In the substrate according to the eleventh embodiment, unlike with the configuration shown in FIG. 3, an upper protection layer 1107 such as a metal protection layer serving as a cavitation resistant layer is provided on first and second protection layers 1106a and 1106a′ as shown in FIG. 14.

The second protection layer 1106a′ having a layer thickness of 100 nm was formed as a silicon nitride layer by Cat-CVD on the first protection layer 1106a composed of a silicon nitride layer having a layer thickness of 150 nm formed by RS-CVD, in a similar manner as the tenth embodiment. Lastly, a Ta layer having a thickness of 100 nm was formed as the upper protection layer 1107 by sputtering, and then patterning was performed. Thus, a substrate for an ink jet head shown in FIG. 14 was produced.

The upper protection layer 1107 composed of a Ta layer has a thermal conductivity higher than that of the first and second protection layers 1106a, 1106a′, and therefore the upper protection layer 1107 does not decrease the thermal efficiency significantly. Furthermore, since the upper protection layer 1107 is formed directly on the dense insulating protection layer 1106a′, it transfers heat energy coming from the heat generating portion 1104′ to the heat generating portion 1108 efficiently to thereby enable the heat energy to act effectively in generating a bubble or discharging ink.

### Twelfth Embodiment

In the twelfth embodiment, a first protection layer 1106a and a second protection layer 1106a′ similar to those in the tenth embodiment were formed. As the first protection layer 1106a, a silicon oxynitride layer having a film thickness of 200 nm was formed by RS-CVD. As the source gases in RS-CVD, NH₃ gas was introduced at a flow rate of 500 sccm, O₂ gas was introduced at a flow rate of 200 sccm, SiH₄ gas was introduced at a flow rate of 20 sccm and Ar gas was introduced at a flow rate of 50 sccm. The deposition pressure was set to 20 Pa, and the temperature of the base plate was set to 300° C. In this case, the film stress was 500 MPa (tensile stress).

Then, the second protection layer 1106a′ composed of a silicon nitride layer was formed on the first protection layer 1106a using Cat-CVD. As the source gases, NH₃ gas was introduced at a flow rate of 50 sccm, SiH₄ gas was introduced at a flow rate of 5 sccm and H₂ gas was introduced at a flow rate of 100 sccm. The deposition pressure was set to 4 Pa, the temperature of the heating catalyst was set to 1700° C. and the temperature of the base plate was set to 350° C. In this case, the layer thickness was 100 nm, and the film stress was 500 MPa (tensile stress).

### Thirteenth Embodiment

In the thirteenth embodiment, a silicon nitride layer having a layer thickness of 100 nm was formed as a first protection layer 1106a using RS-CVD. The source gases used were SiH₄ gas and NH₃ gas, and film deposition was performed under the conditions of a base plate temperature of 400° C. and a deposition pressure of 0.5 Pa.

As a second protection layer 1106a′, a silicon nitride layer having a layer thickness of 50 nm was formed using Cat-CVD. As the source gases, NH₃ gas was introduced at a flow rate of 50 sccm, SiH₄ gas was introduced at a flow rate of 5 sccm and H₂ gas was introduced at a flow rate of 100 sccm. The deposition pressure was set to 4 Pa, the temperature of the heating catalyst member was set to 1700° C., and the temperature of the base plate was set to 100° C. The film stress in this case was 400 MPa (tensile stress).

### Comparative Example 2

A substrate for an ink jet was produced in the same manner as the tenth embodiment except that the insulating protection layer was formed by plasma CVD. The source gases used were SiH₄ gas and NH₃ gas, the base plate temperature was 400° C., the deposition pressure was 0.5 Pa, and the film stress was 900 MPa (compressive stress). The layer thickness of the insulating protection layer thus formed was 250 nm.

### (Evaluation of Substrate for Ink Jet Head and Ink Jet Head)

### <Result of Evaluation of Resistance to Ink>

The substrates for an ink jet head according to the tenth, twelfth and thirteenth embodiments and comparative example 2 were immersed in an ink liquid and left in a temperature controlled bath kept at 70° C. in three days, and then the change in the layer thickness of the insulating protection layer between before and after the above process was examined. In result, while the thickness of the silicon nitride layer in the substrate for an ink jet head according to comparative example 2 had decreased by approximately 80 nm, the silicon nitride layer in the substrates for an ink jet head according to the embodiments had decreased only by approximately 10 nm. This result showed that the silicon nitride layer in the embodiments had good resistance to ink. In addition, it was found that from the viewpoint of resistance to ink, forming the layer that is in direct contact with ink by Cat-CVD yields better result than forming it by RS-CVD.

It is considered that this is because the insulating protection layer in the substrate for an ink jet head according each of these embodiments is composed of multiple layers including at least the uppermost layer formed by Cat-CVD and an underlying layer formed by RS (radical shower)-CVD in contrast to a silicon nitride layer formed by plasma CVD in the substrate according to comparative example 2. Thus, by using an insulating protection layer having this specific multi-layer configuration, a reliable ink jet head that has good coverage performance at step portions and free from development of cracks at the step portions can be provided.

In addition, it was found that forming at least the uppermost insulating protection layer by Cat-CVD provides superior resistance to ink.

### <Head Characteristics>

The ink jet heads produced using the substrates for an ink jet head according to the tenth to thirteenth embodiments and comparative example 2 were attached to an ink jet recording apparatus, and the bubble generation start voltage Vth at which ink discharge began was measured. In addition, printing durability test was performed. The test was performed by printing a general test pattern provided in the ink jet recording apparatus on A4 paper sheets. In this process, pulse signals with a drive frequency of 15 KHz and a drive pulse width of 1 μs mere supplied, and the bubble generation start voltage Vth was determined. The results are shown in Table 2.

TABLE 2

| | bubble generation | |
|---|---|---|
| | start voltage | drive voltage |
| | Vth [V] | Vop [V] |
| 10th embodiment | 14.2 | 18.5 |
| 11th embodiment | 15.9 | 20.7 |
| 12th embodiment | 15.0 | 19.5 |
| 13th embodiment | 13.8 | 17.9 |
| comparative | 15.0 | 19.5 |
| example 2 | | |

In the case of a substrate having the configuration shown in FIG. 3 and including a first insulating protection layer formed by RS-CVD and a second protection layer formed by Cat (catalyst)-CVD, the bubble generation start voltage Vth was 14.2 V (tenth embodiment).

In the cases of the substrates according to the eleventh to thirteenth embodiments also, similar results were obtained, namely the bubble generation start voltage Vth was decreased by approximately 5%, and hence a decrease in power consumption.

Further, recording of a standard document containing 1500 letters was performed at a drive voltage Vop equal to the bubble generation start voltage Vth multiplied by a factor of 1.3. All of the ink jet heads according to the tenth to thirteenth embodiments could perform recording on more than 5000 sheets, and deterioration of recording quality did not occur.

On the other hand, in the case of the ink jet head according to comparative example 2, printing was disabled after recording on approximately 1000 sheets. This was found to be due to breakage of the insulating protection layer caused mainly by cavitation and elution by ink. As per the above, it was found that the ink jet heads to which the present invention is applied can record images stably over a long period of time and have superior durability.

In the above described embodiments, the layer that is in direct contact with ink is formed using RS-CVD or Cat-CVD, and at least the layer that covers the step portions between the electrode wiring and the heat generating resistor layer is formed by RS-CVD that can form a layer having superior coverage performance. However, the layer that is in direct contact with ink may be formed by plasma CVD, insofar as the extent of elution of the protection layer by ink is not so large as to affect discharge characteristics of the head taking into consideration properties of the ink and the usable life of the head. In this case, if the protection layer has a multi-layer configuration in which a protection layer having superior coverage performance formed by RS-CVD is provided under (i.e. on the side facing the heat generating resistor layer and the electrode wiring layer) a protection layer formed by plasma CVD, the layer to be in direct contact with ink may be formed by plasma CVD.

It is also advantageous to constitute the insulating protection layer according to the present invention by a plurality of layers, and provide at least a protection layer having superior step coverage performance formed by RS-CVD under (i.e. on the side facing the heat generating resistor layer and the electrode wiring layer) a protection layer having superior resistance to ink formed by Cat-CVD.

Furthermore, it is also advantageous to provide a protection layer having superior resistance to ink formed by Cat-CVD as the uppermost layer of the insulating protection layer and provide a protection layer having superior step coverage performance formed, by RS-CVD as the lowermost layer.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2007-141773, filed May 29, 2007, 2007-200935 filed Aug. 1, 2007, and 2008-083726 filed Mar. 27, 2007 which are hereby incorporated by reference herein in their entirety.

1. A substrate for a liquid discharge head comprising:
a heat generating resistor layer;
wiring electrically in contact with the heat generating resistor layer;
an insulating protection layer that covers the heat generating resistor layer and the wiring; and
a liquid passage;
the heat generating resistor layer, the wiring, the insulation protection layer and the liquid passage being formed in order on an insulating layer formed on a base plate, and the insulating protection layer being a layer formed by radical shower CVD.

2. A substrate for a liquid discharge head according to claim 1, wherein the composition of the insulating protection layer varies along the layer thickness direction.

3. A substrate for liquid discharge head according to claim 1, wherein the insulating protection layer comprises a plurality of layers.

4. A substrate for a liquid discharge head according to claim 1, wherein the insulating protection layer comprises a silicon nitride layer, a silicon oxynitride layer, a silicon oxycarbide layer or a silicon carbonitride layer.

5. A substrate for a liquid discharge head according to claim 1, wherein the insulating protection layer comprises a plurality of layers, which include at least a layer formed by radical shower CVD.

6. A substrate for a liquid discharge head according to claim 1, wherein the insulating protection layer comprises a plurality of layers, which include at least a layer formed by radical shower CVD provided under a layer formed by catalyst CVD.

7. A substrate for a liquid discharge head according to claim 6, wherein each of the plurality of layers comprised in the insulating protection layer independently comprises a silicon nitride layer or silicon oxynitride layer.

8. A substrate for a liquid discharge head according to claim 7, wherein the uppermost layer in the insulating protection layer is a silicon nitride layer.

9. A substrate for a liquid discharge head according to claim 1, wherein a protection layer made of a metal is formed on the insulating protection layer.

10. A method of manufacturing a substrate for a liquid discharge head in which a heat generating resistor layer, wiring electrically in contact with the heat generating resistor layer, an insulating protection layer that covers the heat generating resistor layer and the wiring, and a liquid passage are formed in order on an insulating layer formed on a base plate, the method comprising:
forming the insulating layer on the base plate;
forming the heat generating resistor layer on the insulating layer;
forming a metal layer to be formed into the wiring on the heat generating resistor layer;
removing a part of the metal layer to form the wiring and the heat generating resistor layer exposed through the wiring; and
forming the insulating protection layer that covers the wiring and the heat generating resistor layer exposed through the wiring,
wherein the insulating protection layer is formed by radical shower CVD in which a material gas and a gas for generating radicals are supplied.

11. A method of manufacturing a substrate for a liquid discharge head according to claim 10, wherein the composition of the insulating protection layer is varied along the layer thickness direction.

12. A method of manufacturing a substrate for a liquid discharge head according to claim 10, wherein the insulating protection layer comprises a plurality of layers.

13. A method of manufacturing a substrate for a liquid discharge head according to any one of claims 10 to 12, wherein the insulating protection layer comprises a silicon nitride layer, a silicon oxynitride layer, a silicon oxycarbide layer or a silicon carbonitride layer.

14. A method of manufacturing a substrate for a liquid discharge head according to claim 10 further comprising, after forming the insulating protection layer by radical shower CVD, depositing an insulating protection layer using a CVD other than radical shower CVD.

15. A method of manufacturing a substrate for a liquid discharge head according to claim 10 further comprising, after forming the insulating protection layer using radical shower CVD, depositing an insulating protection layer using catalyst CVD.

16. A method of manufacturing a substrate for a liquid discharge head according to claim 12, wherein each of the plurality of layers comprised in the insulating protection layer independently comprises a silicon nitride or silicon oxynitride layer.

17. A method of manufacturing a substrate for a liquid discharge head according to claim 16, wherein the uppermost layer in the insulating protection layer comprises a silicon nitride layer.

18. A method of manufacturing a substrate for a liquid discharge head according to claim 10, wherein a protection layer made of a metal is formed on the insulating protection layer.

19. A method of manufacturing a substrate for a liquid discharge head according to claim 10, wherein the insulating protection layer is formed under a condition in which the temperature of the base plate is equal to or lower than 400° C.

20. A method of manufacturing a substrate for a liquid discharge head according to claim 10, wherein the gas for generating radicals comprises ammonia.

21. A method of manufacturing a substrate for a liquid discharge head according to claim 10, wherein the gas for generating radicals comprises ammonia and oxygen.

22. A liquid discharge recording head using a substrate for a liquid discharge head according to claim 1.
